(19) United States
(12) Patent Application Publication
(10) Pub. No.: US 2005/0241294 A1
(43) Pub. Date: Nov. 3, 2005

(54) Injector system for rocket motors

(76) Inventor: Anthony Joseph Cesaroni, Sarasota, FL (US)

Correspondence Address: ARENT FOX PLLC, 1050 CONNECTICUT AVENUE, N.W., SUITE 400, WASHINGTON, DC, 20036, US

(21) Appl. No.: 11/115,396

(22) Filed: Apr. 27, 2005

Related U.S. Application Data
(60) Provisional application No. 60/565,822, filed on Apr. 28, 2004.

(51) Int. Cl. F02K 9/72

(52) U.S. Cl. 60/251; 60/258

(57) ABSTRACT

An injector system for a rocket motor, such as hybrid rocket motors, comprises a plenum having at least one element, wherein at least a portion of the at least one element is porous.

### FIELD OF THE INVENTION

The present invention relates to an injector system for a rocket motor and, in particular, to an injector system for a hybrid rocket motor.

### BACKGROUND OF THE INVENTION

A hybrid rocket motor is a rocket motor that uses both a fuel and an oxidizer, each being in a different state. In typical hybrid rocket motors, a solid fuel and a liquid oxidizer is used. Hybrid rocket motors offer numerous potential advantages over solid or liquid rocket motors. Some potential benefits include high mass fraction, low cost, rapid deployment, reduced storage and transportation restrictions, throttling ability, and configurable thrust and mission profiles.

In a classical hybrid rocket motor, the liquid oxidizer is fed into one end of the rocket motor. The liquid oxidizer passes through an annular column of a fuel grain, whereby combustion occurs on the surface of the fuel grain. The oxidizer/fuel ratio decreases as the oxidizer passes along the annular column. This is referred to as a shifting oxidizer/fuel ratio.

Since classical hybrid rocket motors are not pressure dependent, the fuel flow is non-linearly dependent on the oxidizer flow. Therefore, there is a huge trade-off in impulse with respect to classical hybrid rocket motors, which results in an inefficient process. Similarly, as the oxidizer flow is decreased, fuel rich gas results, which again provides an inefficient process that, essentially, throws away impulse.

In an AFT injected hybrid rocket motor, both the oxidizer and fuel are injected into a post chamber for mixing. This AFT configuration eliminates the shifting oxidizer/fuel ratio of the classical hybrid rocket motor. Unlike the classical hybrid rocket motor, the combustion in the AFT injected hybrid rocket motor is extremely efficient. Such rocket motors, however, suffer from the disadvantages of non-uniform injection of oxidizer, combustion instability, and insufficient cooling of the injector system, which may cause portions of the injector to burn-up and/or melt. Therefore, when designing an injector system, heat transfer, combustion performance, and combustion stability are some of the main functions to consider.

Oxidizer atomization and vaporization typically dictate the performance of injector systems. Traditionally, and as further described in the description, oxidizer has been injected through an annulus or through holes, small jets, or ports in an injector system, in order to inject streams of oxidizer to further promote oxidizer atomization and vaporization. Such injector systems, however, do not address the issue of insufficient cooling of the injector system, which may cause portions of the injector to burn-up and/or melt.

Hence, there is a need for injector systems for rocket motors to obviate and/or mitigate at least some of the shortcomings of the presently known injector systems.

### SUMMARY OF THE INVENTION

In accordance with one aspect of the present invention, there is provided an injector system for a rocket motor comprising: a plenum having at least one element, wherein at least a portion of the at least one element is porous.

In accordance with another embodiment of the present invention, there is provided the injector system for a rocket motor as described above, wherein the plenum comprises:

a first faceplate and a second faceplate with a space therebetween for receiving the oxidizer, the first faceplate and the second faceplate each having at least one aperture;

at least one open-ended hollow member having a first end portion, a second end portion and a passageway therethrough, the passageway being in communication with one aperture of the first faceplate and one aperture of the second faceplate, wherein at least one of the first end portion and the second end portion is coupled to and/or integral with the first faceplate and the second faceplate, respectively, and

the at least one element comprising at least one of the first faceplate, the second faceplate and the at least one open-ended hollow member.

In accordance with other embodiments of the present invention, the at least one element comprises at least one of a ceramic, an open-celled foam, a sintered material and a metal.

In accordance with another embodiment of the present invention, there is provided a rocket motor comprising the injector system as described above. In yet another embodiment, the rocket motor is an AFT injected hybrid rocket motor.

In accordance with another embodiment of the present invention, there is provided an AFT injected hybrid rocket motor comprising:

a liquid oxidizer section containing a liquid oxidizer;

a gas generator section containing a self-decomposing solid fuel that produces gaseous fuel;

a post chamber; and

an injector system as described above, the injector system separating the post chamber from the liquid oxidizer section and the gas generator section, whereby gaseous fuel is capable of passing through the injector system and the oxidizer is capable of transpiring through the injector system, wherein the gaseous fuel and oxidizer mix in the post chamber to effect combustion thereof.

The novel features of the present invention will become apparent to those of skill in the art upon examination of the following detailed description of the invention. It should be understood, however, that the detailed description of the invention and the specific examples presented, while indicating certain embodiments of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

Some embodiments of the present invention will now be described more fully with reference to the accompanying drawings, wherein like numerals denote like parts:

FIGS. 1A, 1B, and 1C are representative examples of classical AFT injected hybrid rocket motors shown in partial cross-section;

FIGS. 2A and 2B show a cross-sectional view of an injector system of the classical AFT injected hybrid rocket motors of FIGS. 1A and 1B, respectively;

FIG. 2C shows a cross-sectional view of a modified injector system of the classical AFT injected hybrid rocket motor of FIG. 1B;

FIG. 3 shows a cross-sectional view of another example of an injector system of classical AFT injected hybrid rocket motors;

FIG. 4 shows a cross-sectional view of a first embodiment of an injector system of the present invention;

FIG. 5A shows a cross-sectional view of a portion of a second embodiment of an injector system of the present invention;

FIG. 5B shows an elevational view of a portion of the second embodiment of the injector system of FIG. 5A;

FIG. 5C shows a perspective view of a tube and a porous annular ring of the second embodiment of the injector system of FIG. 5A;

FIG. 6 shows a cross-sectional view of a portion of a third embodiment of an injector system of the present invention;

FIG. 7 shows a cross-sectional view of a portion of a fourth embodiment of an injector system of the present invention; and

FIG. 8 shows a cross-sectional view of a portion of a fifth embodiment of an injector system of the present invention.

### DETAILED DESCRIPTION

The invention relates to an injector system for a rocket motor.

In an embodiment of the present invention, the invention relates to an injector system for an AFT injected hybrid rocket motor. The injector system of the AFT injected hybrid rocket motor of the present invention promotes injection of an oxidizer into a fuel stream and at the same time mitigates heat transfer to the oxidizer and improves cooling of the injector to substantially inhibit melting of portions of the injector.

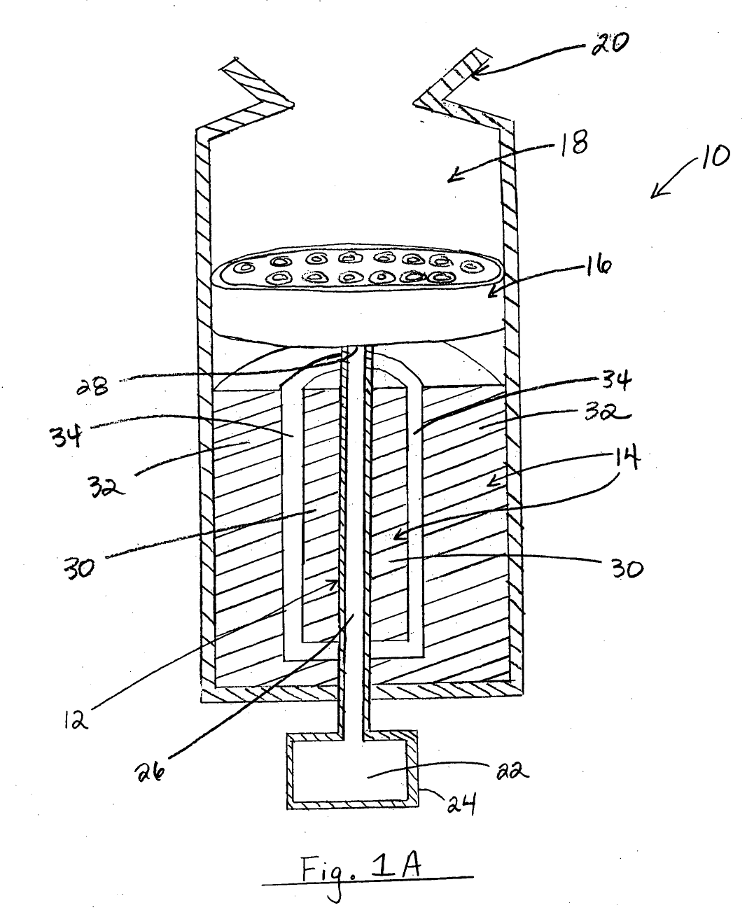

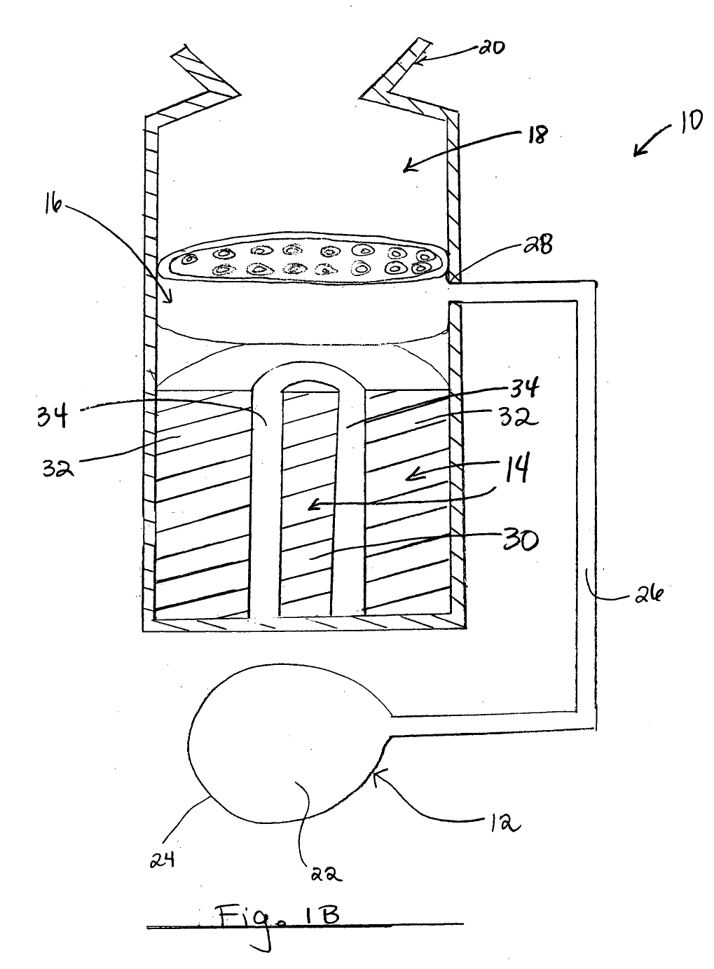

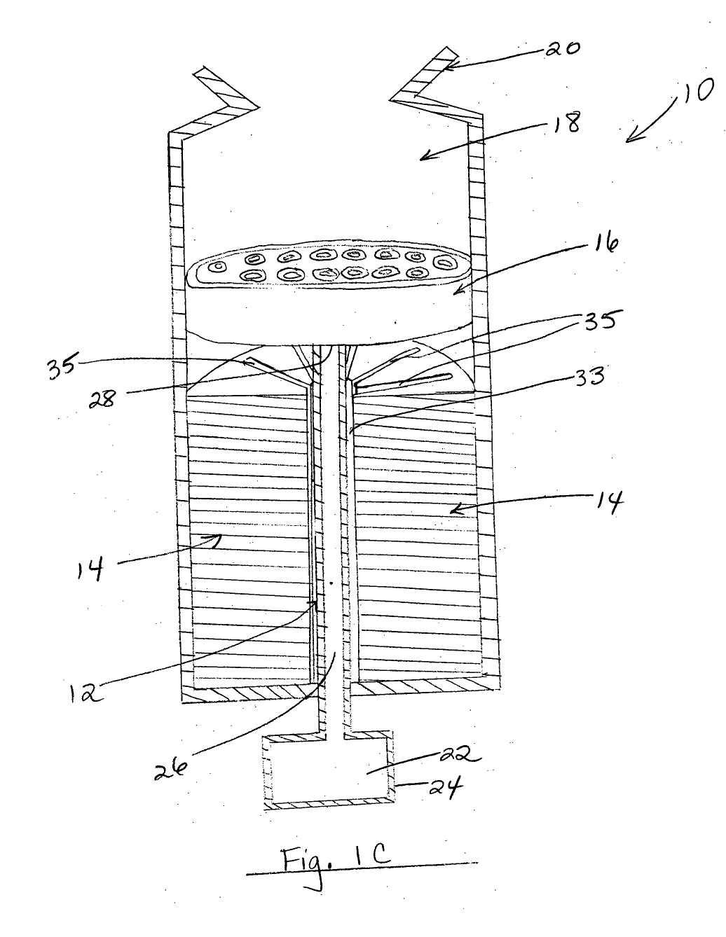

Representative examples of classical AFT injected hybrid rocket motors are shown in FIGS. 1A, 1B, 1C, 2A and 2B, and are indicated generally by numeral 10. The AFT injected hybrid rocket motor 10 has a liquid oxidizer section 12, a gas generator section 14, a typical injector system 16, a post chamber 18 and a nozzle 20.

The liquid oxidizer section 12 contains a liquid oxidizer 22 in a tank 24. Coupled to the tank 24 is an oxidizer passageway 26, wherein an open end portion 28 of the oxidizer passageway 26 terminates into the injector system 16. During operation, the liquid oxidizer 22 travels along the oxidizer passageway 26 and into the injector system 16.

In FIGS. 1A and 1B, the gas generator section 14 contains a central rod of solid fuel 30 that surrounds the oxidizer passageway 26, as shown in FIG. 1A, or does not, as shown in FIG. 1B. A tube of solid fuel 32 surrounds the central rod of solid fuel 30 with a gap 34 between the central rod of solid fuel 30 and the tube of solid fuel 32. This is referred to as a rod and tube fuel grain configuration. Once the solid fuel of the rod and tube fuel grain configuration is ignited, the solid fuel burns in the absence of additional oxidizer, and hot fuel rich gas results. During combustion, the burning surface area of the rod and tube fuel grain configuration remains relatively constant during combustion. For instance, as the central rod of solid fuel 30 burns, the diameter of the rod 30 decreases and subsequently, the surface area of the central rod of solid fuel 30 decreases. At the same time, however, the tube of solid fuel 32 is burning, increasing its internal diameter and therefore, its surface area. Therefore, the burning surface area remains relatively constant throughout combustion since the increasing surface area of the tube of solid fuel 32 cancels the decreasing surface area of the central rod of solid fuel 30. Maintaining a relatively constant surface area throughout the burn provides optimal thrust.

In FIG. 1C, the gas generator section 14 contains a star shaped solid fuel 31 that surrounds the oxidizer passageway 26. The star shaped solid fuel 31 has gaps 35 that extend the length of the solid fuel 31. The star shaped solid fuel 31 surrounds the oxidizer passageway 26 with a gap 33 between the solid fuel 31 and the oxidizer passageway 26. The burning surface area of the solid fuel remains relatively constant throughout combustion.

The injector system 16 of FIGS. 1A, 1B and 1C is shown in more detail in FIGS. 2A and 2B. FIGS. 2A and 2B are a cross-sectional view of the injector system 16 shown in FIGS. 1A and (1B and 1C), respectively. The injector system 16 of FIGS. 2A and 2B comprises a plenum 36 having a first faceplate 38 and a second faceplate 40 with a space 42 therebetween. In FIG. 2A, the open end portion 28 of the oxidizer passageway 26 extends through the second face plate 40. In FIG. 2B, the open end portion 28 of the oxidizer passageway 26 extends through the side of the plenum 36. During operation, the liquid oxidizer 22 is injected along the oxidizer passageway 26 and through the open end portion 28 of the passageway 26 and fills the space 42 of the injector system 16.

Both the first faceplate 38 and the second faceplate 40 include apertures 44 and 46, respectively. Apertures 44 of the first faceplate 38 are substantially co-axially aligned with the apertures 46 of the second faceplate 40. A wall 48 defines each of the apertures 44 of the first faceplate 38 and a wall 50 defines each of the apertures 46 of the second faceplate 40.

Tubes 52, each having a first end portion 54 and a second end portion 56, are received within the plenum 36. The first end portion 54 of each tube 52 is received within one of the apertures 44 in the first faceplate 38 of the plenum 36, with an end 53 of the first end portion 54 being flush with a first surface 39 of the first faceplate 38, and the second end portion 56 of each tube 52 is received within each of the substantially co-axially aligned apertures 46 of the second faceplate 40 of the plenum 36, with an end 55 of the second end portion 56 being flush with a second surface 41 of the second faceplate 40, and the remainder of each tube 52 spanning the space 42 of the plenum 36. At the first end portion 54 of each tube 52, there is an annular space 58 defined between each tube 52 and the wall 48 that defines each aperture 44 of the first faceplate 38. The annular space 58 permits oxidizer in the space 42 to pass therethrough into the post chamber 18. The second end portion 56 of each tube 52 is coupled to the wall 50 that defines each aperture 46 of the second faceplate 40. The second end portion 56 of each tube 52 may also be integral with the wall 50.

As mentioned above, during operation, the liquid oxidizer 22 is injected along the oxidizer passageway 26 and through the open end portion 28 of the passageway 26 and fills the space 42 to pressurize the plenum 36. The annular space 58 in the plenum 36 permits pressurized oxidizer, the flow for which is depicted by arrows 60, to pass therethrough into the post chamber 18. As the flow of pressurized oxidizer 60 is passing through the annular space 58, fuel rich gas, depicted by arrows 62, that results from the combustion of the central rod of solid fuel 30 and the tube of solid fuel 32 in the gas generator section 14, is passing through each tube 52. Mixing of the fuel rich gas and the oxidizer occurs in the post chamber 18. The Aft injected hybrid rocket motor 10 then functions as a basic chemical rocket thereafter.

The injector system of, for example, FIGS. 2A and 2B can also be modified to include spool valves 78 and an actuator 80 for controlling the spool valves 78, as shown in FIG. 2C. The actuator 80 is in communication with a shaft (not shown) that rotates to open and close the valves 78. When the valves 78 are open, the valves are in communication with the gas generator section 14 permitting fuel rich gas to flow therethrough. A variety of valves and valve control mechanisms are possible. During normal motor operation, the valves 78 would be closed; however, the motor can be throttled down by reducing the oxidizer flow. By gradually opening the valves 78, the pressure of the fuel rich gas is reduced, which is pressure dependent, and its burn rate will decrease proportionally with reduction in the flow of oxidizer. To terminate the motor operation, the valves 78 can be opened fully and, in most cases, because there is a pressure dependency, the system itself will extinguish depending on the formulation. The motor can also be shipped with the valves opened so it is not effectively a propulsive device.

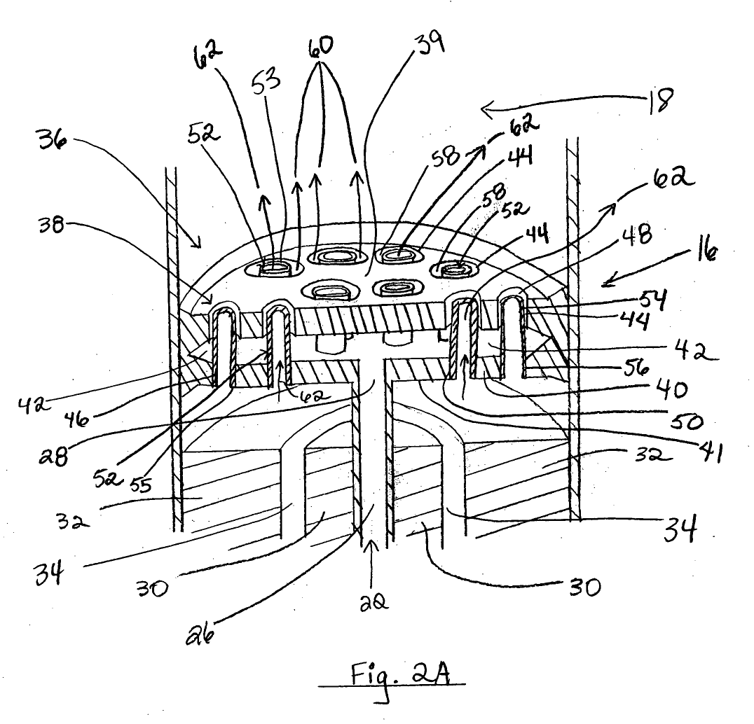

Another example of a typical injector system is shown in FIG. 3. FIG. 3 shows the injector system as used in the classical AFT injected hybrid rocket motor as illustrated in FIG. 1A. Instead of the annulus space 58, holes 64 are arranged in the first faceplate 38 around the first end portion 54 of each tube 52, to inject streams of oxidizer to further atomization and vaporization. During operation, the liquid oxidizer 22 is injected along the oxidizer passageway 26 and through the open end portion 28 of the passageway 26 and fills the space 42 to pressurize the plenum 36. The holes 64 in the plenum 36 permit pressurized oxidizer 60 to pass therethrough into the post chamber 18. As the flow of pressurized oxidizer 60 is passing through the holes 64, fuel rich gas 62 is passing through each tube 52. Mixing of the fuel rich gas and the oxidizer occurs in the post chamber 18.

Unlike the typical injector systems described above in FIGS. 1 to 3, the injector system of the present invention utilizes element(s), wherein at least a portion of the element(s) are porous, in order to promote injection of an oxidizer into a fuel stream and at the same time mitigate heat transfer to the oxidizer and improve cooling of the injector, thus substantially inhibiting melting of portions of the injector.

The embodiments of the injector system of the present invention described below are described using the classical AFT injected hybrid rocket motor 10 shown in FIG. 1A. However, the injector system of the present invention may be used in a variety of rocket motors, including, for example, the rocket motors depicted in FIGS. 1B and 1C. In addition, the injector system of the present invention can also be modified to incorporate valves as described above, for example, with respect to FIG. 2C.

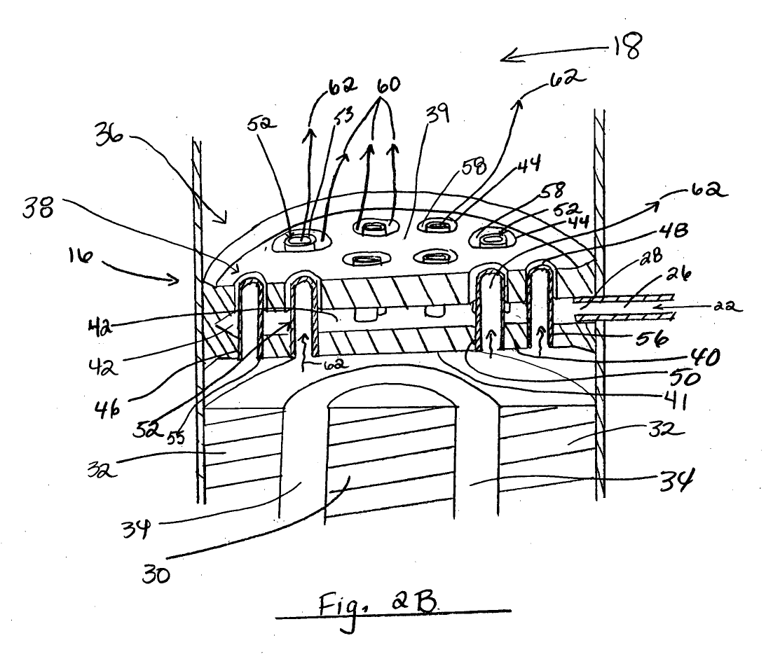

A first embodiment of an improved injector system 116 of the AFT injected hybrid rocket motor 10 is shown in FIG. 4. FIG. 4 is a cross-sectional view of the injector system 116. The injector system 116 comprises a plenum 136 having a first faceplate 138 and a second faceplate 140 with a space 142 therebetween. The open end portion 128 of the oxidizer passageway 126 extends through the second face plate 140.

Both the first faceplate 138 and the second faceplate 140 include apertures 144 and 146, respectively. Apertures 144 of the first faceplate 138 are substantially co-axially aligned with the apertures 146 of the second faceplate 140. A wall 148 defines each of the apertures 144 of the first faceplate 138 and a wall 150 defines each of the apertures 146 of the second faceplate 140.

Tubes 152, each having a first end portion 154 and a second end portion 156, are received within the plenum 136. A porous wall 166 defines each tube 152. The first end portion 154 of each tube 152 is received within one of the apertures 144 in the first faceplate 138 of the plenum 136, with the end 153 of the first end portion 154 being flush with the first surface 139 of the first faceplate 138, and the second end portion 156 of each tube 152 is received within each of the substantially co-axially aligned apertures 146 of the second faceplate 140 of the plenum 136, with the end 155 of the second end portion 156 being flush with the second surface 141 of the second faceplate 140, and the remainder of each tube 152 spanning the space 142 of the plenum 136. The first end portion 154 of each tube 152 is coupled to the wall 148 that defines each aperture 144 of the first faceplate 138. The second end portion 156 of each tube 152 is coupled to the wall 150 that defines each aperture 146 of the second faceplate 140. The first end portion 154 and the second end portion 156 of each tube 152 may also be integral with the walls 148 and 150, respectively.

Additionally, a section 168 of the porous wall 166 of each tube 152 that spans the space 142 of the plenum 136 permits oxidizer to pass through the porous wall 166, which is referred to as transpiration, into a passageway 170 of the tube 152, whereby the oxidizer flows 160 into the post chamber 18. Passage of the oxidizer through the section 168 of the porous wall 166 of each tube 152 that spans the space 142 of the plenum 136 provides a controlled transpiration flow rate of oxidizer, which provides cooling while maintaining substantially efficient oxidizer atomization and vaporization, combustion efficiency and stability. The tubes 152, therefore, are more durable than typical injector tubes since the tubes 152 are less susceptible to the adverse affects of heat flux during combustion.

As the flow of oxidizer 160 is passing through the section 168 of the porous wall 166 of each tube 152 that spans the space 142 of the plenum 136, fuel rich gas, depicted by arrows 162, passes through the passageway 170 of each tube 152 and mixing of the fuel rich gas and the oxidizer occurs in the post chamber 18. In other embodiments, each tube 152 may have only a portion of its' wall porous. For instance, the tube may have an upper portion of section 168 porous and the lower portion non-porous, or variations thereof.

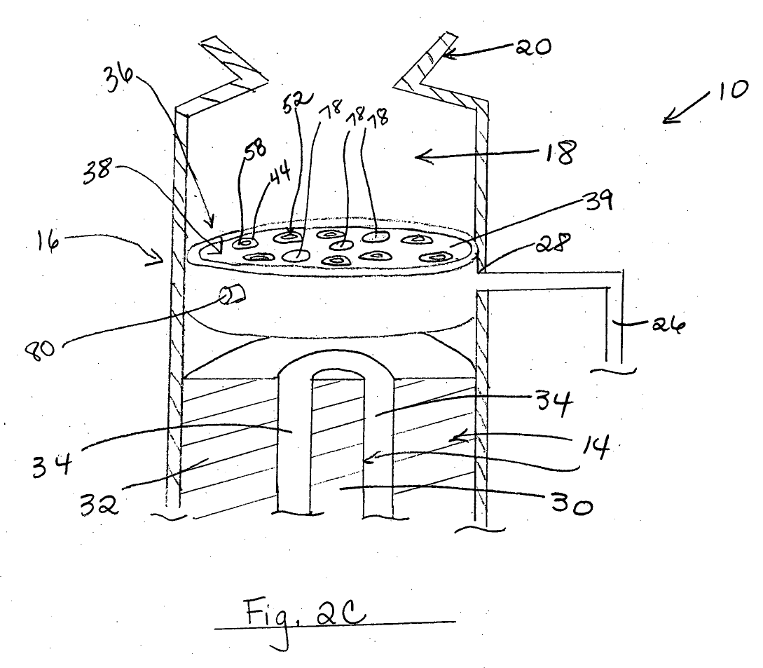

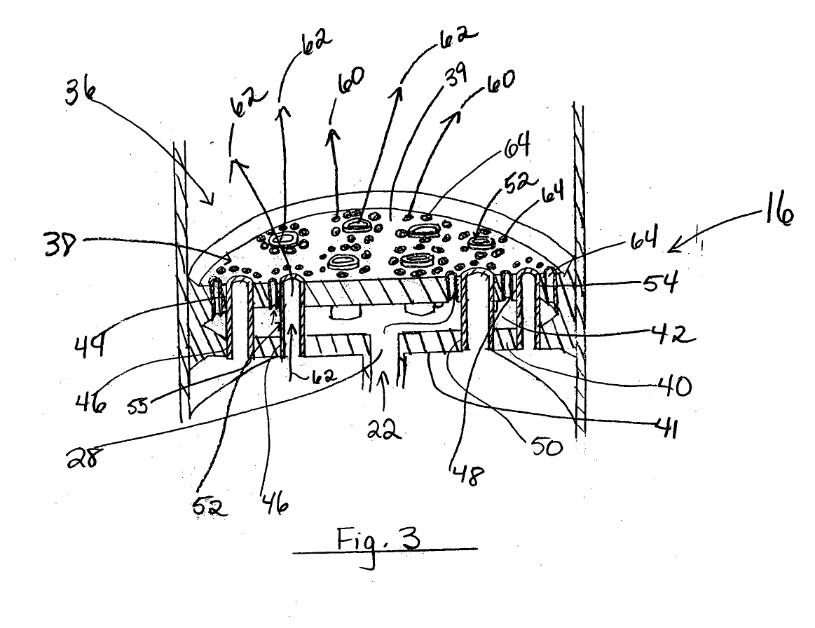

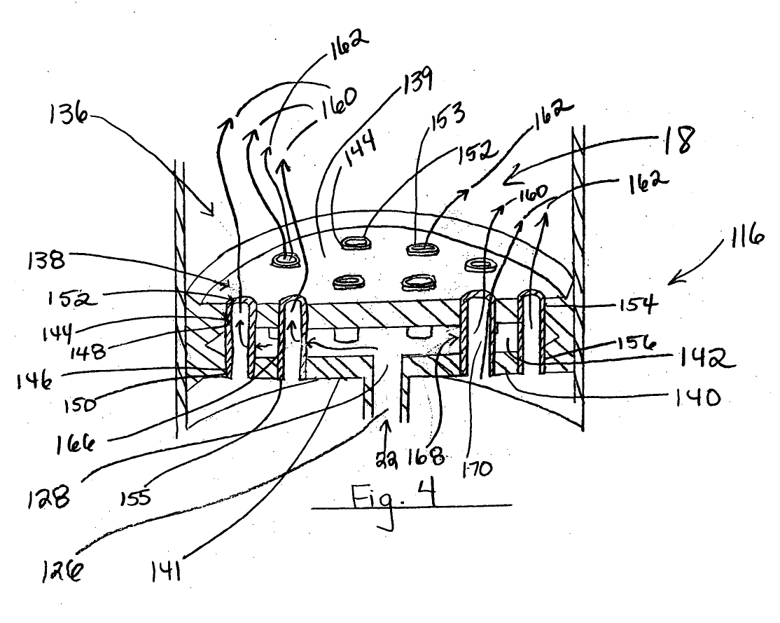

In another embodiment, a variation of the tube 152 of the injector system 116 of the AFT injected hybrid rocket motor 10 is shown in FIGS. 5A, 5B and 5C. FIG. 5A is a cross-sectional view of a tube 252 of a portion of an injector system 216. FIG. 5B is an elevational view of plenum 236 of the injector system 216 and FIG. 5C is a perspective view of the tube 252 having a tubular wall 266 and a porous annular ring 272. The tubular wall 266 is non-porous and the porous annular ring 272 is coupled to and/or integral with one end portion of the tubular wall 266. A first end portion 274 of the porous annular ring 272 is received within one of the apertures 244 in the first faceplate 238 of the plenum 236. An end 273 of the first end portion 274 of the porous annular ring 272 is flush with the first surface 239 of the first faceplate 238 and a second end portion 277 of the porous annular ring 272 extends into the space 242 of the plenum 236. The second end portion 256 of each tube 252 is received within each of the substantially co-axially aligned apertures 246 of the second faceplate 240 of the plenum 236, with the end 255 of the second end portion 256 being flush with the second surface 241 of the second faceplate 240. The portion 274 of the porous annular ring 272 of each tube 252 is coupled to the wall 248 that defines each aperture 244 of the first faceplate 238. The second end portion 256 of each tube 252 is coupled to the wall 250 that defines each aperture 246 of the second faceplate 240. The portion 254 of the porous annular ring 272 and the second end portion 256 of each tube 252 may also be integral with the walls 248 and 250, respectively.

The porous annular ring 272 permits oxidizer to pass therethrough, resulting in transpiration cooling, into a passageway 270 of the tube 252, whereby the oxidizer flows 260 into the post chamber 18 and the porous annular ring 272 also permits oxidizer to pass directly into the post chamber 18. Passage of the oxidizer through the porous annular ring 272 of each tube 252 provides a controlled transpiration flow rate of oxidizer. As described above for the previous embodiments, as the flow of oxidizer 260 is passing through the porous annular ring 272 of each tube 252, fuel rich gas, depicted by arrows 262, passes through the passageway 270 of each tube 252 and mixing of the fuel rich gas and the oxidizer occurs in the post chamber 18.

In other embodiments, the tubular wall 266 of each tube 252 is porous and the tubular wall 266 is integral with the porous annular ring 272. In another embodiment, the second end portion 277 of the porous annular ring 272 does not extend into the space 242 of the plenum 236 but the second end 276 of the second end portion 277 is flush with the second surface 243 of the first faceplate 238 such that the flow of oxidizer 260 occurs through the second end 276 of the porous annular ring 272 and out through the first end 273 of the annular ring 272.

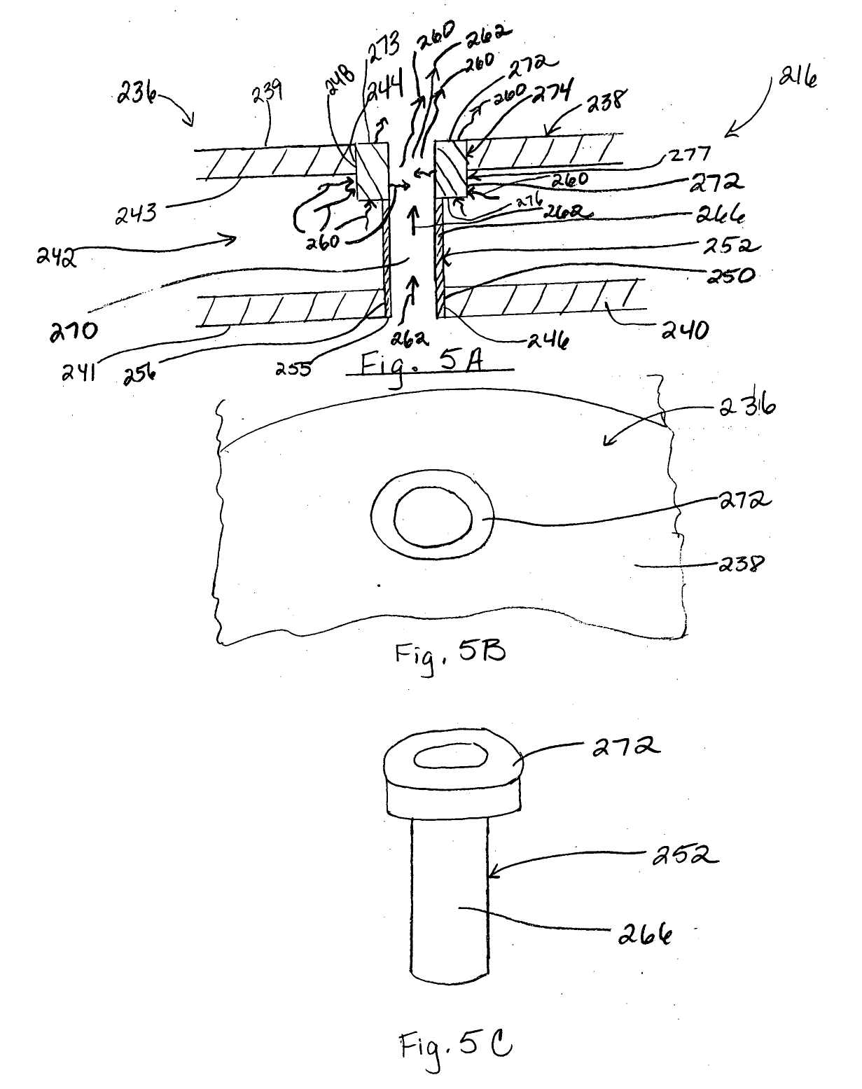

A further variation of the tube 152 of the injector system 116 of the AFT injected hybrid rocket motor 10 is shown in FIG. 6. FIG. 6 is a cross-sectional view of a portion of an injector system 316. The wall 366 of the tube 352 is non-porous. The end 353 of the first end portion 354 of the tube 352 is coupled to the second surface 343 of the first faceplate 338 adjacent to the wall 348 that defines each aperture 344 in the first faceplate 338, wherein a portion of the first faceplate 338 is porous. The second end portion 356 of each tube 352 is received within each of the substantially co-axially aligned apertures 346 of the second faceplate 340 of the plenum 336. The second end portion 356 of each tube 352 is coupled to the wall 350 that defines each aperture 346 of the second faceplate 340, with the end 355 of the second end portion 356 being flush with the second surface 341 of the second faceplate 340.

The portion of the first faceplate 338 that is porous permits oxidizer to pass therethrough into a passageway 370, whereby the oxidizer flows 360 into the post chamber 18, and the portion of the first faceplate 338 that is porous also permits oxidizer to pass directly into the post chamber. The first faceplate 338 may, of course, be completely porous. In other embodiments, the wall 366 of the tubes 352 are completely porous or a portion of the tubes 352 are porous. This, in effect, would substantially promote transpiration cooling of the tubes 352 and also the first faceplate 338 of the plenum 336, where high temperature reactions are occurring.

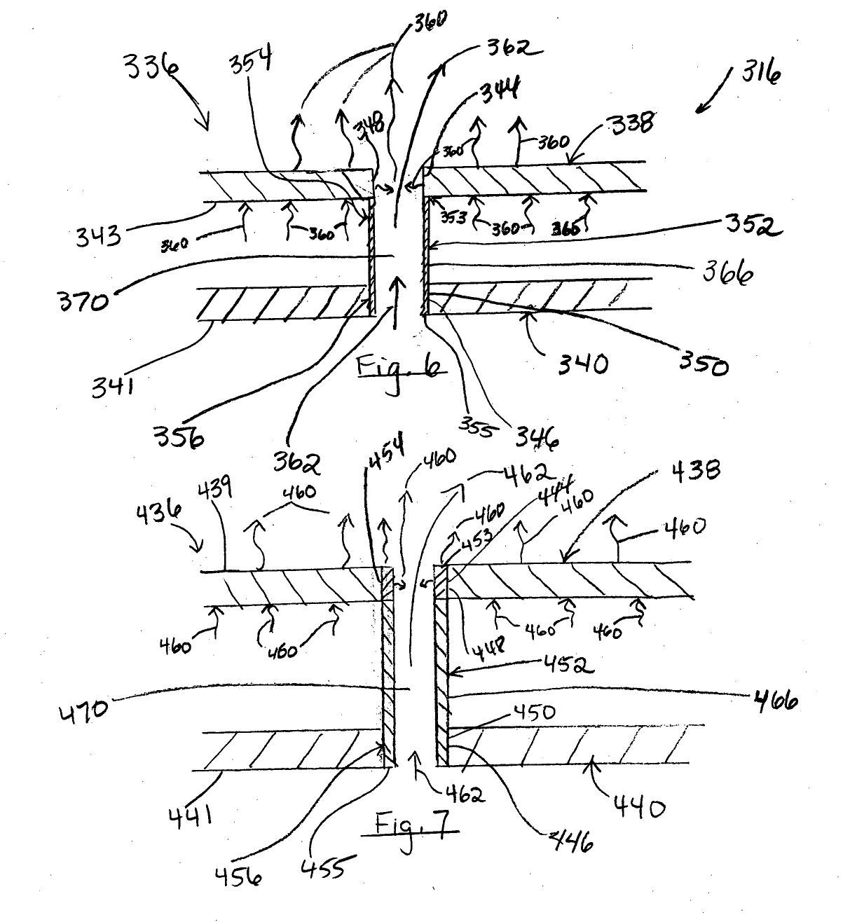

A further variation of the tube 352 of the injector system 316 of the AFT injected hybrid rocket motor 10 is shown in FIG. 7. FIG. 7 is a cross-sectional view of a portion of an injector system 416. A portion of the first faceplate 438 is porous. The first end portion 454 of each tube 452 is received within one of the apertures 444 in the first faceplate 438 of the plenum 436, with the end 453 of the first end portion 454 being flush with the first surface 439 of the first faceplate 438, and the second end portion 456 of each tube 452 is received within each of the substantially co-axially aligned apertures 446 of the second faceplate 440 of the plenum 436, with the end 455 of the second end portion 456 being flush with the second surface 441 of the second faceplate 440. The first end portion 454 of each tube 452 is porous and is coupled to the wall 448 that defines each aperture 444 of the first faceplate 438. The remainder of the tube 452 is non-porous. The second end portion 456 of each tube 452 is coupled to the wall 450 that defines each aperture 446 of the second faceplate 440. The first end portion 454 and the second end portion 456 of each tube 452 may also be integral with the walls 448 and 450, respectively.

During operation, the oxidizer flows 460 through the portion of the first faceplate 438 that surrounds the aperture 444 and through the first end portion 454 of each tube 452 into the passageway 470, whereby the oxidizer flows 460 into the post chamber 18, and the portion of the first faceplate 438 that is porous also permits oxidizer to pass directly into the post chamber. In other embodiments, the tubes 452 are completely porous or a portion of the tubes 452 are porous.

The idea of using porous element(s)/partially porous element(s) in an injector system of a rocket motor can be extended to the conventional injector systems 16 shown in FIGS. 2 and 3. For example, the tubes 52 may be porous or partially porous providing similar transpiration cooling as described above.

One skilled in the art would understand that the plenums may have a variety of porous element(s)/partially porous element(s) to substantially promote transpiration cooling. In certain embodiments, the plenums may have a variety of different porous element(s)/partially porous element(s) such as at least one of tubes, faceplates and annular rings as described herein to provide the desired flow of oxidizer. For example, a plenum may contain some tubes with and without the annular rings, wherein the tubes without the annular rings are porous. In another example, a plenum may contain some tubes with and without the annular rings, wherein the tubes are porous.

One skilled in the art would also understand that the plenums are not limited to the structure of the aforementioned embodiments. There may be a variety of different structural forms of plenums, which may include at least one porous element/partially porous element to substantially promote transpiration cooling of the injector system.

The porous element(s)/partially porous element(s) of the present invention may have a variety of porosities. To provide a suitable flow rate of the oxidizer, the porosity of the porous elements may be varied in size and in placement. For example, one porous element, such as the tube, may have a higher porosity that permits more oxidizer flow therethrough compared to the porous faceplate having a lower porosity. The porosity, of course, may also vary over a single porous element. For instance, the faceplate may have non-uniform porosity.

The porous element(s)/partially porous element(s) may have a wide range of porosities. Some porosities include from about 50 to about 200 microns. The chosen porosity depends upon the configuration of the rocket motor, the type of oxidizer, the mass flow of oxidizer and other operating parameters used.

The porous element(s)/partially porous element(s), such as the tubes, annular rings and faceplates, may be made from ceramics, open-celled foams, sintered materials and/or any suitable metal. Some examples include stainless steel, nickel alloys, and copper. The elements may also be made from any suitable catalytic material to decompose the oxidizer, if necessary, into its reactive components. For example, if hydrogen peroxide is used as the liquid oxidizer, the porous element(s)/partially porous element(s) may be made from catalytic material that decomposes the hydrogen peroxide to superheated water and oxygen. Examples of such catalysts include platinum, graphite, silver, rare-earth metals, and specifically nickel or other suitable substrate coated with silver and samarium nitrate. The liquid oxidizer may be decomposed within the injector system by using other means such as heat. For instance, the liquid oxidizer may be decomposed at elevated temperatures by passage through the injector. For example, such temperatures could be in excess of 1000° K or 1300° K. Combinations of methods utilizing catalytic material and heat may also be used.

Although the tubes, annular rings and apertures of the described embodiments are cylindrical in shape, it is understood that a variety of shapes and sizes may be utilized. For example, the tubes, the annular rings and apertures may be hexagonal, triangular, etc. Tubes can therefore be more broadly referred to as an open-ended hollow member and the annular rings and apertures are understood to encompass other shapes other than cylindrical.

In addition, it is not necessary for the ends of the open-ended hollow member to be flush with the surface of the plenum, as shown in the previous embodiments.

The non-porous plenum elements may be made from any suitable metal or ceramic, similar to that suggested for the porous element(s)/partially porous element(s).

With respect to the tubes and annular rings coupled to the walls of the apertures of the plenums, these elements may be welded, braised, pressed in, rolled in, laser welded, and the like, in order to achieve the appropriate coupling.

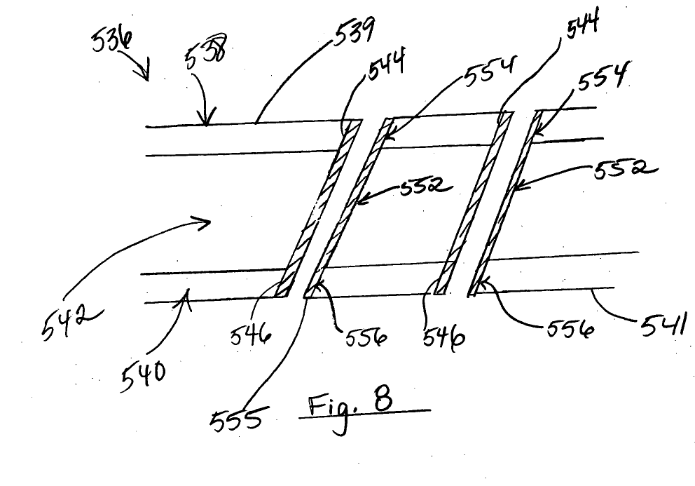

The embodiments of the injector system of the present invention may also encompass injector systems wherein the apertures of the first faceplate may or may not be substantially co-axially aligned with the apertures of the second faceplate. In other words, the first end portion of each tube may be received within one aperture of the first faceplate and the second end portion of each tube may be received within one aperture of the second faceplate, without restricting the positioning of the tube to substantially co-axially aligned apertures. For example, FIG. 8 shows the first end portion 554 of each tube 552 is received within one of the apertures 544 in the first faceplate 538 of the plenum 536, with the end 553 of each first end portion 554 being flush with the first surface 539 of the first faceplate 538, and the second end portion 556 of each tube 552 is received within one of the apertures 546 of the second faceplate 540 of the plenum 536, with the end 555 of each second end portion 556 being flush with the second surface 541 of the second faceplate 540, with the remainder of each tube 552 spanning the space 542 of the plenum 536. Therefore, the tubes may be shaped in such a manner as to extend from one aperture in the first faceplate 538 to another aperture in the second faceplate 540, without the apertures necessarily being substantially co-axially aligned.

A wide variety of liquid oxidizers and solid fuels may also be used, as discussed herein.

The liquid oxidizer may be any suitable liquid oxidizer known to one skilled in the art and mixtures thereof. Examples of suitable liquid oxidizers are liquid oxygen, liquid fluorine, a combination of liquid oxygen and liquid fluorine, liquid air, liquid hydrogen peroxide, liquid nitrogen tetroxide, mixtures of liquid nitrogen tetroxide and other nitrates, modified liquid oxides of nitrogen (MON), liquid nitrous oxide, and nitric acid. Liquid oxygen is more commonly used since it has the highest oxygen content, is cheap, relatively safe, and non-toxic.

The liquid oxidizer may be delivered through the injector system of the present invention by any of a number of known means, including gas blow-down, pumps or other means.

The gas generator section 14 of the AFT injected hybrid rocket motor has been described above. In an AFT injected hybrid rocket motor, the solid fuel may be any suitable energetic material and shape for rocket motors known to one skilled in the art that sustains self-decomposition or a composite solid propellant that has sufficient oxidizer contained therein to sustain self-decomposition (e.g. operate close to stoichiometric ratio) and produce fuel rich gas.

Examples of energetic materials include cyclotrimethylene trinitramine (RDX), cyclotetramethylene tetranitramine (HMX) or hexanitroisoazowurzitane (CL-20), an energetic plasticizer, an energetic polymer and mixtures thereof.

Examples of energetic plasticizers include butanetriol trinitrate (BTTN), trimethylolethane trinitrate (TMETN), triethyleneglycol dinitrate (TEGDN) and glycidyl azide plasticizer (GAP plasticizer), and mixtures thereof. The solid fuel may be replaced in whole or in part by energetic polymers, examples of which are glycidyl azide polymer (GAP), bis-azidomethyloxetane (BAMO), azidomethylmethoxetane (AMMO), bis-azidomethyloxetane/azidomethyl-methoxetane copolymer (BAMO/AMMO), polynitramethylmethoxetane (polyNMMO) and mixtures thereof.

In some embodiments of the solid fuel, the fuel contains a solid oxidizer. Examples of solid oxidizers include ammonium perchlorate (AP), ammonium nitrate (AN), hydrazinium nitroformate (HNF), ammonium dinitramide (ADN) and other solid or semi-solid oxidizers such as, hydroxylammonium nitrate (HAN), hydroxylammonium perchlorate (HAP) and nitronium perchlorate (NP).

Solid propellants that are proportioned to decompose in a very fuel rich condition are known to one skilled in the art. Examples include a solid propellant fuel, such as a rubber binder, having 35% by weight ammonium perchlorate compared to a conventional solid propellant fuel that has 75% by weight ammonium perchlorate. Various metals, ballistic modifiers, other energetic materials including, for example, HMX, RDX, HNF, AND, could be added to provide suitable solid propellants.

As mentioned, the solid fuel may further contain a metal, such as a hydro-reactive metal, that will enhance specific impulse, combustion efficiency and/or enhance regression rate. Examples of such metals include aluminum, magnesium, boron, beryllium, lithium, silicon, mixtures thereof, and combinations of such metals with other metals. Other metals are known. The metals may be in the form of alloys, including combinations of the aforementioned aluminum, magnesium, boron, beryllium, lithium and silicon, and combinations of such metals with other metals. Hydrides of these metals are equally applicable. Metals and combinations of metals and metal hydrides used to enhance combustion efficiency and/or enhance regression rate are known to those skilled in the art.

The solid fuel may contain known modifiers to increase or decrease burn or regression rate, modify pressure sensitivity exponent, alter mechanical properties, modify plume signature, enhance processability and the like.

A decomposition catalyst for certain liquid oxidizers, such as hydrogen peroxide, may also be included in the solid fuel. This catalyst may replace the use of catalyst in the tubes of the injector system, or it may supplement its action. Examples of such catalysts include potassium permanganate and manganese dioxide.

Although the present invention is particularly applicable to an AFT injected hybrid rocket motor, it will be understood that the injector system of the present invention is also applicable for use with other types of rocket motors. For instance, and without be limited thereto, in the classical hybrid rocket motor, the injector system of the present invention can be used to inject the oxidizer through the annular column of a fuel grain, wherein the injector system promotes atomization, vaporization and transpiration cooling. In another example, the injector system of the present invention could be used in a reverse hybrid rocket motor, wherein the “gas generator section” is formulated to inject oxidizer and the “oxidizer section” now injects fuel. Examples of oxidizers used in the “gas generator section” may contain solid oxidizers as described in U.S. Pat. No. 6,647,888 and U.S. Patent Application No. 20040244890, incorporated herein by reference.

The injector system of the present invention offers a number of potential benefits. For instance, the injector system may be used in throttling and start-stop operations, thereby providing additional control and versatility to the rocket. The injector system greatly reduces the cost for manufacture of such systems since the tubes are porous and thus, it is unnecessary to be concerned with maintaining the non-porous norm.

The terms “a” or “an” used throughout the specification may be understood to mean one or more.

The embodiments and examples set forth herein are presented to best explain the present invention and its practical application and to thereby enable those skilled in the art to make and utilize the invention. Those skilled in the art, however, will recognize that the description and examples are presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

1. An injector system for a rocket motor comprising:
a plenum having at least one element, wherein at least a portion of said at least one element is porous.

2. The injector system of claim 1, wherein said at least one element is porous.

3. The injector system of claim 1, wherein said at least one element comprises at least one of a faceplate and an open-ended hollow member.

4. The injector system of claim 1, wherein the plenum comprises:
a first faceplate and a second faceplate with a space therebetween for receiving the oxidizer, the first faceplate and the second faceplate each having at least one aperture;
at least one open-ended hollow member having a first end portion, a second end portion and a passageway therethrough, said passageway being in communication with one aperture of the first faceplate and one aperture of the second faceplate, wherein at least one of the first end portion and the second end portion is coupled to and/or integral with the first faceplate and the second faceplate, respectively, and
said at least one element comprises at least one of the first faceplate, the second faceplate and said at least one open-ended hollow member.

5. The injector system of claim 4, wherein each aperture of the first faceplate is substantially co-axially aligned with one aperture of the second faceplate, the passageway of said at least one open-ended hollow member is substantially co-axially aligned with said at least one aperture of the first faceplate and the co-axially aligned aperture of the second faceplate.

6. The injector system of claim 4, wherein the second end portion of said at least one open-ended hollow member is coupled and/or integral with the second faceplate.

7. The injector system of claim 4, wherein the first end portion of said at least one open-ended hollow member and the second end portion of said at least one open-ended hollow member are coupled and/or integral with the first faceplate and the second faceplate, respectively.

8. The injector system of claim 4, wherein the first end portion is received within one aperture of the first faceplate and the second end portion is received within one aperture of the second faceplate.

9. The injector system of claim 4, wherein the first end portion is a first end of said at least one open-ended hollow member.

10. The injector system of claim 7, wherein the first end portion is a first end of said at least one open-ended hollow member and the second end portion is received within one aperture of the second faceplate.

11. The injector system of claim 7 wherein said at least one element comprises at least one of the first faceplate and said at least one open-ended hollow member.

12. The injector system of claim 7, wherein said at least one element comprises the first faceplate.

13. The injector system of claim 7, wherein said at least one element comprises said at least one open-ended hollow member.

14. The injector system of claim 4, wherein said at least one element comprises the first faceplate and said at least one open-ended hollow member, wherein the first end portion of said at least one open-ended hollow member is porous.

15. The injector system of claim 5, wherein a portion of said at least one open-ended hollow member spans the space between the first faceplate and the second faceplate.

16. The injector system of claim 15, wherein the portion of said at least one open-ended hollow member spanning the space between the first faceplate and the second faceplate is porous.

17. The injector system of claim 4, wherein said at least one open-ended hollow member comprises an annular ring and a tubular wall, the annular ring being coupled to and/or integral with the tubular wall, said at least one element comprising at least one of the first faceplate, the second faceplate, said tubular wall and the annular ring.

18. The injector system of claim 17, wherein at least a portion of the annular ring is received within said at least one aperture of the first faceplate.

19. The injector system of claim 18, wherein said portion of the annular ring is coupled and/or integral with the first faceplate, said at least one element comprising the annular ring.

20. The injector system of claim 1 wherein said at least one element comprises a non-uniform porosity.

21. The injector system of claim 1 wherein said at least one element comprises at least one of a ceramic, an open-celled foam, a sintered material and a metal.

22. The injector system of claim 1, wherein said at least one element substantially promotes transpiration cooling.

23. A rocket motor comprising the injector system of claim 1.

24. The rocket motor of claim 23 is a reverse hybrid rocket motor.

25. The rocket motor of claim 23 is an AFT injected hybrid rocket motor.

26. An AFT injected hybrid rocket motor comprising:
a liquid oxidizer section containing a liquid oxidizer;
a gas generator section containing a self-decomposing solid fuel that produces gaseous fuel;
a post chamber; and
an injector system according to claim 1, the injector system separating the post chamber from the liquid oxidizer section and the gas generator section, whereby gaseous fuel is capable of passing through the injector system and the oxidizer is capable of transpiring through the injector system, wherein the gaseous fuel and oxidizer mix in the post chamber to effect combustion thereof.

27. The AFT injected hybrid rocket motor of claim 24, wherein the liquid oxidizer is selected from the group consisting of liquid oxygen, liquid fluorine, a combination of liquid oxygen and liquid fluorine, liquid air, liquid hydrogen peroxide, liquid nitrogen tetroxide, mixtures of liquid nitrogen tetroxide and nitrates, modified liquid oxides of nitrogen (MON), liquid nitrous oxide, and nitric acid.

28. The AFT injected hybrid rocket motor of claim 24, wherein the self-decomposing solid fuel comprises at least one of an energetic material and a composite solid propellant that has sufficient oxidizer contained therein to sustain self-decomposition.
